(19) United States
(12) Patent Application Publication
(10) Pub. No.: US 2013/0255982 A1
(43) Pub. Date: Oct. 3, 2013

(54) POWER TOOL

(71) Applicant: HITACHI KOKI CO., LTD., Tokyo (JP)

(72) Inventors: Shigeru Takahashi, Ibaraki (JP); Katsuhiro Oomori, Ibaraki (JP); Tomomasa Nishikawa, Ibaraki (JP)

(73) Assignee: HITACHI KOKI CO., LTD., Tokyo (JP)

(21) Appl. No.: 13/769,148

(22) Filed: Feb. 15, 2013

(30) Foreign Application Priority Data
Mar. 27, 2012 (JP) 2012-7062

(51) Int. Cl. B25F 5/00

(52) U.S. Cl. CPC B25F 5/001
USPC 173/47

(57) ABSTRACT

A power tool, in which a case that is connected to a housing and the case houses a reducer mechanism that decelerates an output of an electric motor and an impact mechanism that transmits an output of the reducer mechanism to a tip tool, is provided. The power tool further includes an inner cover that covers an opening of the case, a ring gear included in the reducer mechanism, a spindle that is rotatably supported by a bearing, and a space portion that is placed between the inner cover and the ring gear and in a periphery of the bearing, and capable of stocking grease. A through hole, which communicates with the inside and outside of the case through the space portion, is formed in the inner cover.

### CROSS-REFERENCE TO RELATED APPLICATION

The present application claims priority from Japanese Patent Application No. 2012-070602 filed on Mar. 27, 2012, the content of which is hereby incorporated by reference into this application.

### TECHNICAL FIELD OF THE INVENTION

The present invention relates to a power tool in which a tip tool is driven by a driving source, such as an electric motor, a pneumatic pressure motor, or the like.

### BACKGROUND OF THE INVENTION

As one example of the power tool in which a tip tool is driven by a driving source, such as an electric motor, a pneumatic pressure motor, or the like, an impact driver, an impact wrench or the like has been known. A driver bit and a socket serving as tip tools are attached to the impact driver and the impact wrench. The tip tool to be attached to the impact driver and the impact wrench is driven to rotate and an impact force (impact) is applied thereto.

The above-mentioned power tool is provided with a driving source, a reducer mechanism for decelerating the rotation of the driving source, a transmission mechanism that transmits the output of the reducer mechanism to the tip tool, and a housing that houses these members. The housing is provided with a handle unit to be grabbed by a worker, and a body unit that is integrally molded with one end of the handle unit. The driving source, the reducer mechanism and the transmission mechanism are housed in the body unit. More specifically, the driving source is housed on one end side of an internal space of the body unit, and the reducer mechanism and the transmission mechanism are housed in a case that is housed on the other end side of the internal space of the body unit.

In the power tool having the above-described structure, air inside the case is expanded due to heat generated during operations of the reducer mechanism and the transmission mechanism, resulting in an increase of the internal pressure. In such a situation, grease which is shielded inside the case for lubricating the reducer mechanism and the transmission mechanism sometimes leaks from the case.

For this reason, Japanese Patent Application Laid-Open Publication No. 2008-62342 (Patent Document 1) describes an electric tool in which an air release passage having a labyrinth shape is formed between the case and the housing so that the internal space of the case is allowed to communicate with the air through the air release passage.

Japanese Patent Application Laid-Open Publication No. 2011-131358 (Patent Document 2) describes a hammer drill in which a pressure adjusting mechanism for preventing the grease leakage is installed in a gear housing.

Japanese Patent Application Laid-Open No. 2009-178803 (Patent Document 3) describes an impact tool in which a through hole is formed in a hammer case so as to prevent the grease leakage.

### SUMMARY OF THE INVENTION

Since the air release passage described in Patent Document 1 has the labyrinth shape, its flow resistance is high. The pressure adjusting mechanism described in Patent Document 2 largely jetties toward the inside of a gear housing. Therefore, when this pressure adjusting mechanism is adopted in a power tool provided with a planetary gear mechanism, the overall length of the power tool is required to be made longer so as to avoid interference between the planetary gear and the pressure adjusting mechanism. As described in Patent Document 3, when a through hole is formed in a hammer case, the strength of the hammer case is lowered, resulting in degradation of the durability of the power tool.

A preferred aim of the present invention is to effectively suppress a pressure increase inside a case in which a reducer mechanism and a transmission mechanism are housed, without causing an increase in size and degradation in durability of a power tool.

In one aspect of the present invention, a power tool is provided with a reducer mechanism of a planetary gear type that decelerates an output of a driving source and a transmission mechanism that transmits the output of the reducer mechanism to a tip tool. The reducer mechanism and the transmission mechanism are housed in a case, and the case is connected to a housing. The power tool is further provided with a cover member that covers an opening of the case, a ring gear that is included in the reducer mechanism and supported by the cover member, a bearing that rotatably supports a spindle that is included in the transmission mechanism, the bearing being disposed inside the case, and a space portion that is placed between the cover member and the ring gear in a periphery of the bearing, the space portion being capable of stocking a grease, and a first through hole formed in the cover member so as to allow the inside and outside of the case to communicate with each other through the space portion.

According to the present invention, it is possible to effectively suppress a pressure increase inside the case in which the reducer mechanism and the transmission mechanism are housed, without causing an increase in size and degradation in durability of the power tool.

### BRIEF DESCRIPTIONS OF THE DRAWINGS

FIG. 1 is a longitudinal cross-sectional view illustrating an impact driver in which the present invention is adopted;

FIG. 2 is a partially enlarged cross-sectional view illustrating a cross section of the impact driver that is exploded along the line A-A in FIG. 1; and

FIG. 3 is an exploded perspective view illustrating shapes and layouts of an inner cover, felt members, rubber members and a ring gear.

### DESCRIPTIONS OF THE PREFERRED EMBODIMENTS

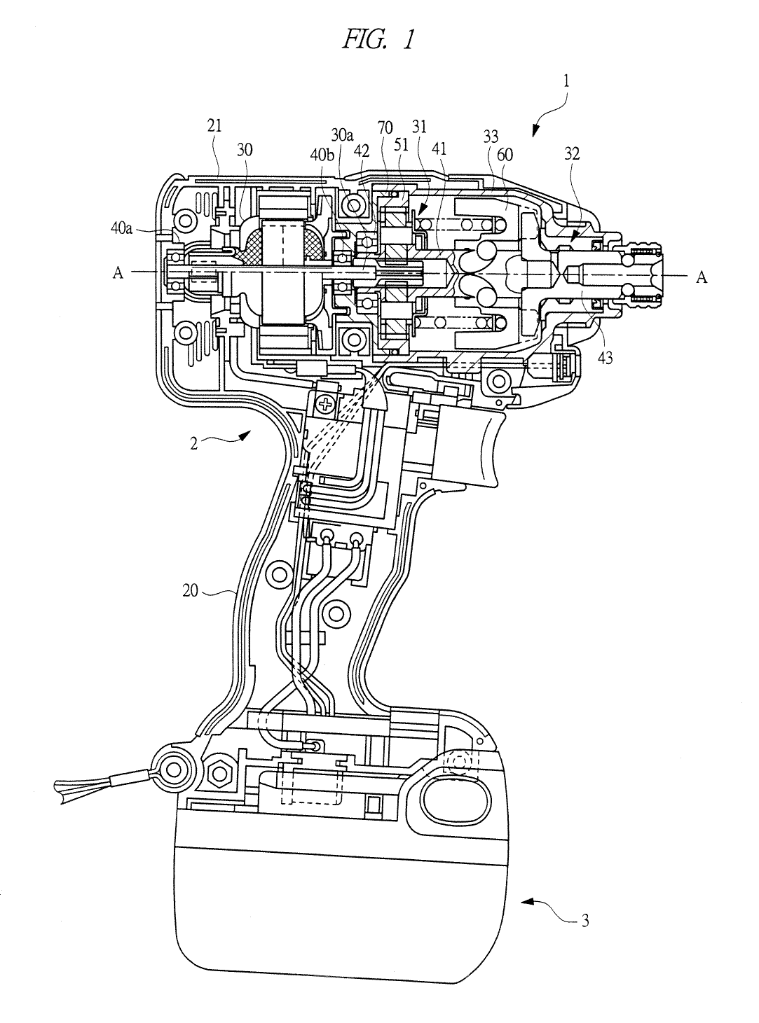

The following description will explain one example of an embodiment of the present invention in detail. FIG. 1 is a longitudinal cross-sectional view illustrating an impact driver 1 in which the present invention is adopted. To the impact driver 1, a driver bit (not illustrated) serving as a tip tool is attached. Moreover, the impact driver 1 is provided with a transmission mechanism that transmits power to the driver bit attached to the impact driver 1. At the time of use of the impact driver 1, a rotary impact force is applied to a screw member that is a subject to be fastened by the driver bit.

As illustrated in FIG. 1, the impact driver 1 includes a housing 2 and a battery case 3 that is detachably attached to the housing 2. Therefore, this impact driver 1 is a cordless device or a portable device.

The housing 2 has a handle unit 20 to be grabbed by a worker, that is, an operator, and a body unit 21 having a cylindrical shape that is integrally molded with one end of the handle unit 20. On one end side of an inner space of the body unit 21, an electric motor 30, which is driven by a battery (not illustrated) serving as a power source housed in the battery case 3, is housed. On the other end side of the inner space of the body unit 21, a reducer mechanism 31 and a case 33 made of metal (an aluminum alloy in the present embodiment) and housing an impact mechanism 32 serving as a transmission mechanism are housed. An output shaft 30a of the electric motor 30 is rotatably supported on bearings 40a and 40b disposed on the front and rear sides in the axial direction. When using the impact driver 1, the one end side of the body unit 21 in which the electric motor 30 is housed forms the rear end.

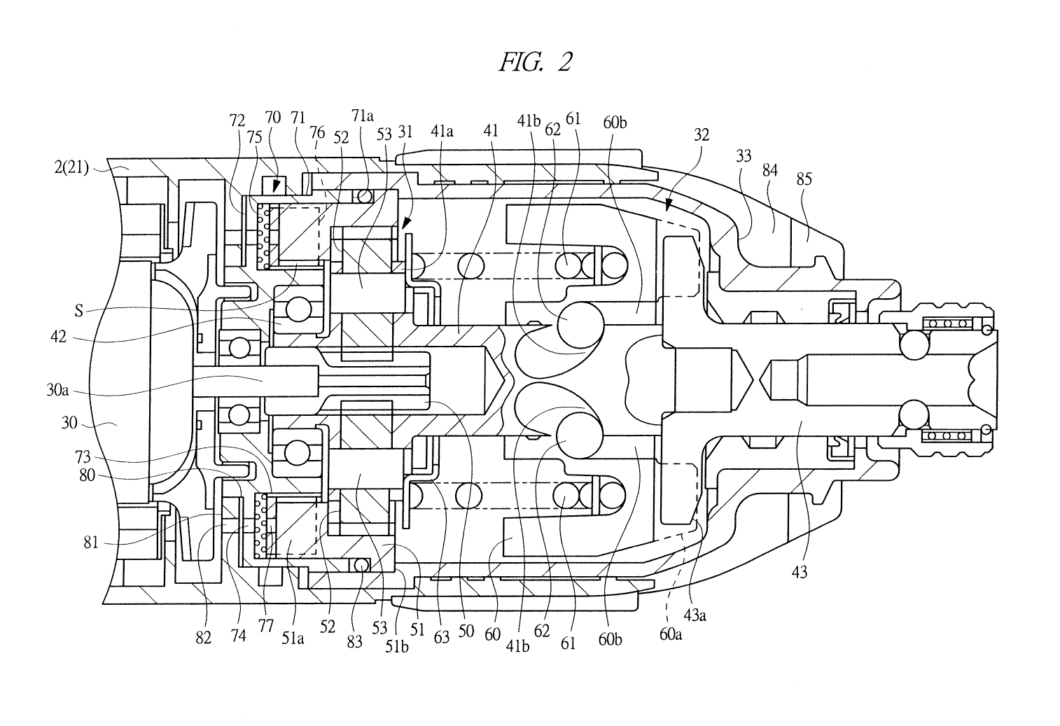

As illustrated in FIG. 2, on the front side in the axial direction of the output shaft 30a, a spindle 41 included in the impact mechanism 32 is disposed coaxially with the output shaft 30a, and rotatably supported by a bearing 42. An anvil 43 is disposed on the front side of the spindle 41. The anvil 43 is a holder to which the tip tool, not illustrated, is detachably attached. A small diameter portion is formed on the tip of the spindle 41, and this small diameter portion is inserted into a center hole formed on a bottom surface of the anvil 43. The anvil 43 is pivotally and rotatably supported by the small diameter portion of the spindle 41. With respect to the driver bit serving as the tip tool, there are many types, and an optimal driver bit is selected depending on the type of a screw member to be fastened, and the selected type of driver bit is attached to the anvil 43.

The rotation of the electric motor 30 is decelerated by the reducer mechanism 31 of a planetary gear type and transmitted (inputted) to the spindle 41. The reducer mechanism 31 includes a sun gear (pinion gear 50) attached to the tip of the output shaft 30a, an outer gear (ring gear 51) fixed relative to the rotation direction of the output shaft 30a and two planetary gears 52 that are meshed with the pinion gear 50 and the ring gear 51. The respective planetary gears 52 are pivotally and rotatably supported by a support shaft 53 secured to a flange unit 41a formed on the rear end portion of the spindle 41. By using this reducer mechanism 31 of the planetary gear type, the rotation of the electric motor 30 is decelerated and transmitted (inputted) to the spindle 41.

A cylindrical hammer 60 is attached on the outside of the spindle 41 so as to be movable along the axial direction. A plurality of hammer claws 60a formed on the tip of the hammer 60 are made to be meshed with anvil claws 43a formed on the anvil 43. The anvil 43 is rotated by the hammer 60 in accordance with the mesh between the hammer claws 60a and the anvil claws 43a. Ina cylindrical groove formed in the hammer 60, a spring 61 that abuts a bottom surface of the groove and the flange unit 41a of the spindle 41 is disposed. A pressing force toward the anvil 43 is applied to the hammer 60 by the spring force of the spring 61.

Steel balls 62 are disposed between a cam groove 41b formed on an outer circumferential surface of the spindle 41 and a cam groove 60b formed on an inner circumferential surface of the hammer 60, so that the rotation of the spindle 41 is transmitted to the hammer 60 by the steel balls 62. The hammer 60 is reciprocatably moveable in the axial direction with respect to the spindle 41, so that, by the movement of the hammer 60 in the axial direction exerted by the spring force of the spring 61 and the rotation of the hammer 60 exerted by the spindle 41, the anvil claws 43a are impacted by the hammer claws 60a.

When the striking energy of the hammer 60 is reduced to cause a reduction in the rotary torque of the anvil 43 after the impacting, the hammer 60 repels from the anvil 43. Then, the hammer 60 retracts toward the reducer mechanism 31 along the cam grooves 41b and 60b. However, prior to abutting against a stopper 63, the hammer 60 is made to move forward toward the anvil 43 by the spring force of the spring 61. Here, the rotation of the spindle 41 is transmitted to the hammer 60 via the steel balls 62 disposed between the two cam grooves 41b and 60b, so that the hammer 60 is accelerated. The rotation of the spindle 41 continues even during the retraction of the hammer 60 toward the stopper 63; therefore, when the hammer claws 60a that have moved over the anvil claws 43a again impact the anvil claws 43a, the anvil 43 is impacted by the hammer 60 that has been rotated by 180 degrees. In this manner, the impacting onto the anvil 43 is repeatedly carried out by the movements of the hammer 60 in the axial directions and rotations thereof around the axis, and the striking torque is continuously given to the screw member so that the screw member is tightened.

In this case, inside the body unit 21 of the housing 2, a cover member (inner cover 70), which is fixed relative to the rotation direction of the output shaft 30a of the electric motor 30, is installed. The inner cover 70, which is fixed to the body unit 21 as described above, is on the other hand fitted to the case 33 so as to cover the opening of the case 33. The ring gear 51, which is installed inside the case 33, is engaged with the inner cover 70 so as to be fixed relative to the rotation direction of the output shaft 30a of the electric motor 30. The following description will explain the structure in detail.

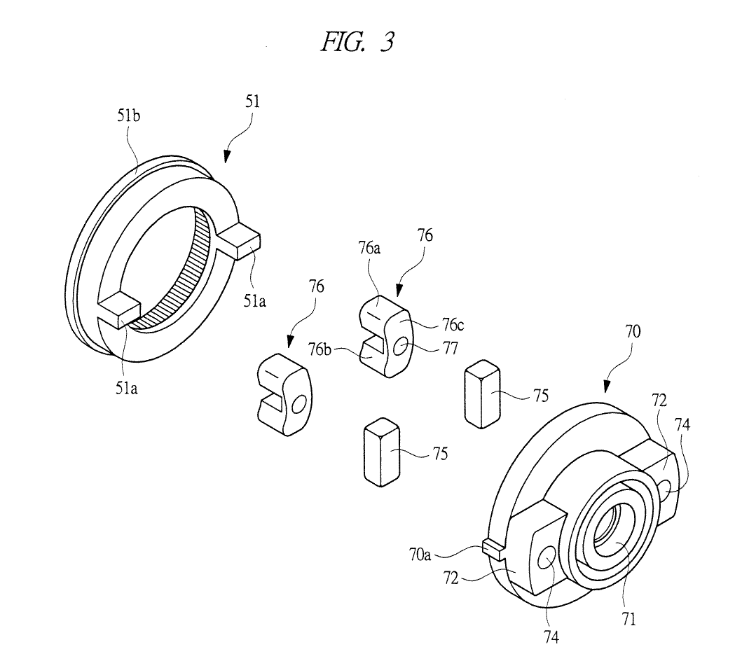

As illustrated in FIG. 3, a shaft hole 71 through which the output shaft 30a of the electric motor 30 (see FIGS. 1 and 2) is inserted is formed in the center of the inner cover 70. Moreover, on one surface (rear surface) of the inner cover 70, two convex portions 72, which are opposed to each other across the center of the shaft hole 71 therebetween, are integrally molded. As illustrated in FIG. 2, on the inside of each of the convex portions 72, a recessed space (concave portion 73) is formed so as to stock grease, and on the bottom of the concave portion 73, a first through hole (through hole 74) is formed. Moreover, in each of the concave portions 73, a felt member 75 serving as a filter member and a rubber member 76 serving as an elastic member are housed.

As illustrated in FIG. 3, the felt member 75 has an almost rectangular pillar shape. The rubber member 76 has a substantially U-letter shape having an upper side horizontal portion 76a and a lower side horizontal portion 76b opposed to each other, as well as a vertical portion 76c that connects ends of the upper side horizontal portion 76a and the lower side horizontal portion 76b with each other, and on the vertical portion 76c, a second through hole (through hole 77) is formed. As illustrated in FIG. 2, the felt member 75 and the rubber member 76 are housed in the concave portion 73 in this order, with the felt member 75 being sandwiched between the bottom of the concave portion 73 and the vertical portion 76c (FIG. 3) of the rubber member 76. The through hole 74 of the inner cover 70 and the through hole 77 of the rubber member 76 face each other so as to communicate with each other, with the felt member 75 being interposed therebetween. Moreover, the felt member 75 is located between the bottom of the concave portion 73 and the vertical portion 76c (FIG. 3) in a compressed and squashed state into a flat plate.

As illustrated in FIG. 2, on an inner circumferential surface of the body unit 21 of the housing 2, two engaging portions (engaging concave portions 80) that are engaged with the convex portions 72 of the inner cover 70 are formed. The inner cover 70 is detented relative to the body unit 21 by the engagement between the convex portions 72 and the engaging concave portions 80. Moreover, on a rib 81 forming the engaging concave portion 80, a third through hole (through hole 82), which faces and is communicated with the through hole 74 of the inner cover 70, is formed. That is, the through hole 77 of the rubber member 76, the through hole 74 of the inner cover 70 and the through hole 82 of the rib 81 are aligned on a straight line and communicating with one another.

As illustrated in FIGS. 2 and 3, on one surface (rear surface) of the ring gear 51 facing the inner cover 70, two protrusions 51a, each having a flat-plate shape, are integrally molded. The ring gear 51 is detented relative to the body unit 21 by the insertion of each protrusion 51a into the concave portion 73 of the inner cover 70. More specifically, each protrusion 51a of the ring gear 51 is inserted between the upper side horizontal portion 76a and the lower side horizontal portion 76b of the rubber member 76 housed in the concave portion 73 of the inner cover 70 (see FIG. 3). In other words, the upper side horizontal portion 76a and the lower side horizontal portion 76b of the rubber member 76 face each other, with the protrusion 51a of the ring gear 51 being sandwiched therebetween. In this case, the dimensions and positions of the concave portion 73 and each protrusion 51a to be inserted into the concave portion 73 are determined such that a space portion S (see FIG. 2) is formed between the inner surface (inside surface) of the concave portion 73 and the outer surface (outside surface) of the protrusion 51a that faces the inside surface. As a result, a passage (air release passage) that connects the inside and outside of the case 33 is formed by the space portion S between the inside surface of the concave portion 73 and the outside surface of the protrusion 51a, the through hole 77 of the rubber member 76, the through hole 74 of the inner cover 70 and the through hole 82 of the rib 81. Moreover, most part of the air release passage is composed of the through holes 77, 74 and 82 that are aligned on one straight line. That is, most part of the air release passage is formed into a straight line shape. Moreover, the inner diameters of the through holes 77, 74 and 82 are in common with one another so that there are no step difference on the inside of the passage portion formed by the through holes 77, 74 and 83. Additionally, the felt member 75 is interposed between the through hole 77 and the through hole 74; however, the circulation of air is not interrupted by the felt member 75.

As illustrated in FIG. 3, on the outer circumferential surface of the ring gear 51, a step difference portion 51b is formed over the entire circumference of the outer circumferential surface. At two positions on the outer circumferential surface of the inner cover 70, step difference portions 70a having the same height as that of the step difference portion 51b are formed (in FIG. 3, only one of the step difference portion 70a is illustrated). As illustrated in FIG. 2, the ring gear 51 is fitted into the inside of the inner cover 70, and an area of the outer circumferential surface of the ring gear 51 where no step difference portion 51b is formed is made in contact with the inner circumferential surface of the inner cover 70. On the other hand, an area of the outer circumferential surface of the ring gear 51 where the step difference portion 51b is formed, that is, an upper surface of the step difference portion 51b, and upper surfaces of the step difference portions 70a of the inner cover 70 are made in contact with the inner circumferential surface of the case 33. Moreover, an O-ring 83 is placed between the step difference portion 51b of the ring gear 51 and the step difference portions 70a of the inner cover 70. This O-ring 83 is appressed to the outer circumferential surface of the ring gear 51 and the inner circumferential surface of the case 33 so that air and grease are prevented from leaking through a gap between the upper surfaces of the step difference portions 51b, 70a and the inner circumferential surface of the case 33.

In an impact driver 1 constructed as described above, the air inside the case 33, which is expanded due to heat generated by the reducer mechanism 31 and the impact mechanism 32 during their operations, is released to the outside of the case 33 through the air release passage. In this case, since most of the air release passage is composed of the through holes 77, 74 and 82, the flow resistance of the air release passage is small so that the air inside the case 33 is smoothly released. In addition, since the through holes 77, 74 and 82 forming most part of the air release passage are disposed on one straight line, the flow resistance of the air release passage is made further smaller, and the air inside the case 33 is released further smoothly. Moreover, since the felt member 75 is disposed between the through holes 74 and 77 forming the air release passage, grease stocked in the concave portion 73 is prevented from leaking.

Additionally, the ring gear 51 is detented relative to the inner cover 70 by the protrusion 51a inserted into a gap between the upper side horizontal portion 76a and the lower side horizontal portion 76b of the rubber member 76 housed in the concave portion 73 of the inner cover 70. Therefore, shock in the rotation direction of the ring gear 51 is absorbed by the rubber member 76 so as to be attenuated. Moreover, the felt member 75 is interposed between the vertical portion 76c of the rubber member 76 housed in the concave portion 73 of the inner cover 70 and the bottom of the concave portion 73. Therefore, shock in the axial direction of the ring gear 51 is absorbed by the felt member 75 so as to be attenuated. That is, the rubber member 76 functions as a shock attenuation mechanism that attenuates the shock in the rotation direction of the ring gear 51. Moreover, the felt member 75 functions as an impact alleviating mechanism that attenuates the shock in the axial direction of the ring gear 51. In this case, as described above, the felt member 75 also functions as a filter that prevents grease from leaking.

As illustrated in FIG. 2, the case 33 is covered with a protector 84 made of a soft material such as an elastomer. The protector 84 is fixed to the case 33 by a stopper (a front cap 85) having a ring shape and made of an elastic material such as rubber.

The present invention is not limited by the above-mentioned embodiments, but may be variously modified without departing from the gist of the present invention. For example, in the present embodiment, a space portion for use in stocking grease is formed by the concave portion 73 formed in the inner cover 70; however, this space portion may be formed at an optional position on the circumference of the bearing 42, between the inner cover 70 and the ring gear 51. Moreover, the present invention may be adopted in a power tool other than an impact driver (for example, an impact wrench). The present invention may also be applied to a power tool with a cord. The present invention may be also adopted in a power tool provided with a driving source other than an electric motor, such as a pneumatic pressure motor or the like.

What is claimed is:

1. A power tool in which a case connected to a housing houses a reducer mechanism of a planetary gear type that decelerates an output of a driving source and a transmission mechanism that transmits an output of the reducer mechanism to a tip tool,
the power tool comprising:
a cover member that covers an opening of the case;
a ring gear included the reducer mechanism and supported by the cover member;
a bearing that rotatably supports a spindle included in the transmission mechanism, the bearing being disposed inside the case; and
a space portion that is placed between the cover member and the ring gear and on the periphery of the bearing, and capable of stocking grease,
wherein a first through hole, which makes the inside and outside of the case to communicate with each other through the space portion, is formed in the cover member.

2. The power tool according to claim 1, further comprising:
a concave portion that is formed on a surface facing the ring gear of the cover member; and
a protrusion that is formed on a surface facing the cover member of the ring gear, and inserted into the concave portion of the cover member,
wherein the first through hole is formed at a bottom of the concave portion of the cover member so that at least one portion of the space portion is formed by a gap portion between an inner surface of the concave portion and an outer surface of the protrusion facing the inner surface of the concave portion.

3. The power tool according to claim 2,
wherein a filter member that covers the first through hole is disposed inside the concave portion.

4. The power tool according to claim 3, further comprising:
an elastic member that is disposed inside the concave portion, and having an upper side horizontal portion and a lower side horizontal portion that face each other between which the protrusion id sandwiched, and a vertical portion that connects ends of the upper side horizontal portion and the lower side horizontal portion with each other,
wherein a second through hole that communicates with the first through hole, with the filter member being interposed therebetween, is formed in the vertical portion of the elastic member.

5. The power tool according to claim 1, further comprising:
a rib that is provided on an inner surface of the housing and constitutes an engaging portion that engages with the convex portion formed on the cover member so as to regulate a pivotal movement of the cover member,
wherein a third through hole that communicates with the first through hole is formed in the rib.
